(19) United States
(12) Patent Application Publication
(10) Pub. No.: US 2016/0038262 A1
(43) Pub. Date: Feb. 11, 2016

(54) BRISTLED TOOTHPICK WITH COVER

(71) Applicant: ZEE ZEE CORPORATION, Mississauga (CA)

(72) Inventors: Zenovia Zmiyiwsky, Mississauga (CA); Vera Zmiyiwsky, Mississauga (CA); Robert G. Dickie, King City (CA)

(73) Assignee: Zee Zee Corporation

(21) Appl. No.: 14/919,066

(22) Filed: Oct. 21, 2015

Related U.S. Application Data
(63) Continuation-in-part of application No. 14/063,288, filed on Oct. 25, 2013, now Pat. No. 9,168,115.

(51) Int. Cl. A61C 15/02

(52) U.S. Cl. CPC A61C 15/02

(57) ABSTRACT

A toothpick assembly that is engaged with a cover and is movable between extended, partially extended and retracted positions relative to the cover. The toothpick assembly includes a base with first and second ends; a locking assembly provided at the first end of the base that secures the base to the cover; and a toothpick provided at the second end of the base. The toothpick includes first and second regions. The first region defines sinusoidal grooves in the side faces thereof and a row of bristles extending outwardly from each groove. The bristles are integrally formed with rest of the toothpick assembly and taper in length from the base and towards the second region. The second region is bristle-free and terminates in an upwardly curving tip. The first and second regions taper in width moving toward the tip so that toothpick is easily inserted into an interdental space.

### CROSS-REFERENCE TO RELATED APPLICATIONS

This is a Continuation-in-Part of U.S. patent application Ser. No. 14/063,288 filed Oct. 25, 2013, the entire disclosure of which is incorporated herein by reference.

### BACKGROUND OF THE INVENTION

1. Technical Field

This invention relates generally to dental products and their use. More particularly, this invention relates to a dental care product for removing food particles and plaque from interdental spaces. Specifically, the invention is directed to a toothpick having a tapered end which is triangular in cross-section and has bristles on two opposed faces. The bristles are configured in a serpentine wave on each face, are integrally formed with the rest of the toothpick, and extend outwardly from within recessed regions defined in the faces.

2. Background Information

Dental floss is used to remove residual food particles and plaque from the spaces between the teeth. Many people find floss difficult to use or they fail to use it in the most effective manner. Studies have therefore indicated that floss is not a particularly effective tool in preventing plaque build-up, gingivitis, and periodontitis. Toothpicks may be used to remove food particles from some spaces between the teeth but these devices typically do not clean the teeth effectively. Toothbrushes are also typically unable to penetrate far into and therefore clean the interproximal/interdental spaces adequately. The build-up of food particles and plaque in these spaces can lead to bad breath, infection and staining of the teeth. It is generally considered that if people have a dental care product which is both easy to use and effective, they will be more likely to include the use of that product in their daily dental routine.

In order to provide devices which clean interdental spaces, some have proposed adding bristles to toothpicks to make them more effective cleaning tools. For example, US Publication No. 2008/0251098 (Chen) discloses a toothpick which comprises a rod having bristles at one end. The tip of the rod is circular in cross-sectional shape and the bristles radiate outwardly from the circumferential exterior surface of the rod's tip. Bristles also extend outwardly and forwardly from the tip. One of the issues with this device is that because the bristles radiate outwardly in all directions, the bristles will come into contact with the gingiva when the toothpick is moved back and forth and up and down to remove food particles from the teeth and from the interdental space. The sandpapering effect of these bristles will irritate the gingival tissue. To address this problem, Chen has proposed coating the bristles with one of a variety of substances, such as toothpaste. The idea is that when these coated bristles contact the gingiva, the substance will help the bristles glide over the gingival tissue and thereby be less inclined to cut into and irritate that tissue. While this coating helps address the problems caused by raking the bristles over the gums, it does not completely eliminate this issue. Furthermore, the coating could also have the tendency to render the bristles slightly ineffective at cleaning food particles from the teeth because the coating acts as a lubricant which causes the bristles to easily glide across the food particles and tooth surfaces.

### SUMMARY

While many types of flossers and toothpicks have been fabricated to clean interdental spaces, there remains a need in the art for dental implements which are able to effectively remove plaque and food particles from interdental spaces.

The dental implement disclosed herein is provided for this purpose. A toothpick assembly that is engaged with a cover and movable between extended, partially extended and retracted positions relative to the cover is disclosed herein. The toothpick assembly includes a base with first and second ends; a locking assembly provided at the first end of the base that secures the base to the cover; and a toothpick provided at the second end of the base. The toothpick includes first and second regions. The first region defines sinusoidal grooves in the side faces thereof and a row of bristles extending outwardly from each groove. The bristles are integrally formed with rest of the toothpick assembly and taper in length from the base and towards the second region. The second region is bristle-free and terminates in an upwardly curving tip. The first and second regions taper in width moving toward the tip so that toothpick is easily inserted into an interdental space.

In one aspect, the invention may provide a toothpick assembly comprising a base having a first end and a second end; a locking assembly provided at the first end of the base, said locking assembly being adapted to secure the base to a cover; a toothpick provided at the second end of the base; wherein the toothpick includes a first region and a plurality of bristles extending outwardly from the first region. The plurality of bristles is integrally formed with the first region, and the base, locking assembly, first region and the plurality of bristles are a monolithic unitary component. The first region is generally triangular in cross-section and includes a first face and an apex opposite the first face; and a second face and a third faces extend from opposing ends of the first face to the apex; and wherein some of the plurality of bristles are provided on the second face and some of the plurality of bristles are provided on the third face.

### BRIEF DESCRIPTION OF THE SEVERAL VIEWS OF THE DRAWINGS

A sample embodiment of the invention is set forth in the following description, is shown in the drawings and is particularly and distinctly pointed out and set forth in the appended claims.

FIG. 1 is a first perspective view of a toothpick assembly in accordance with an aspect of the invention, where the toothpick is illustrated in a fully extended first position relative to a cover therefor;

FIG. 2 is a perspective view of the toothpick assembly of FIG. 1, where the toothpick is illustrated in a partially extended second position relative to the cover;

FIG. 3 is perspective view of the toothpick assembly of FIG. 1, where the toothpick is illustrated in a fully retracted third position relative to the cover;

FIG. 4 is a right side view of the toothpick assembly of FIG. 1;

FIG. 5 is a cross-section of the toothpick assembly taken along the plane highlighted in FIG. 1;

FIG. 6 is a top view of the toothpick assembly of FIG. 1;

FIG. 7 is a bottom view of the toothpick assembly of FIG. 1;

FIG. 8 is a right side view of the toothpick of FIG. 1 removed from the cover;

FIG. 9 is a top view of the toothpick of FIG. 8;

FIG. 10 is a cross-section of the toothpick taken along line 10-10 of FIG. 9;

FIG. 11 is a cross-section of the toothpick taken along line 11-11 of FIG. 9;

FIG. 12 is a perspective view of the toothpick removed from the cover;

FIG. 13 is top view of the toothpick;

FIG. 14 is a bottom view of the toothpick;

FIG. 15 is an enlarged perspective view of the highlighted region of FIG. 12 showing the left side of the front end of the toothpick;

FIG. 15a is an enlarged perspective view of the right side of the front end of the toothpick;

FIG. 16 is a side view of the cover of the toothpick assembly;

FIG. 17 is a cross-section taken along line 17-17 of FIG. 16;

FIG. 18 is a top view of the cover;

FIG. 19 is a bottom view of the cover;

FIG. 20 is a top perspective view of the cover; and

FIG. 21 is a bottom perspective view of the cover.

Similar numbers refer to similar parts throughout the drawings.

### DETAILED DESCRIPTION

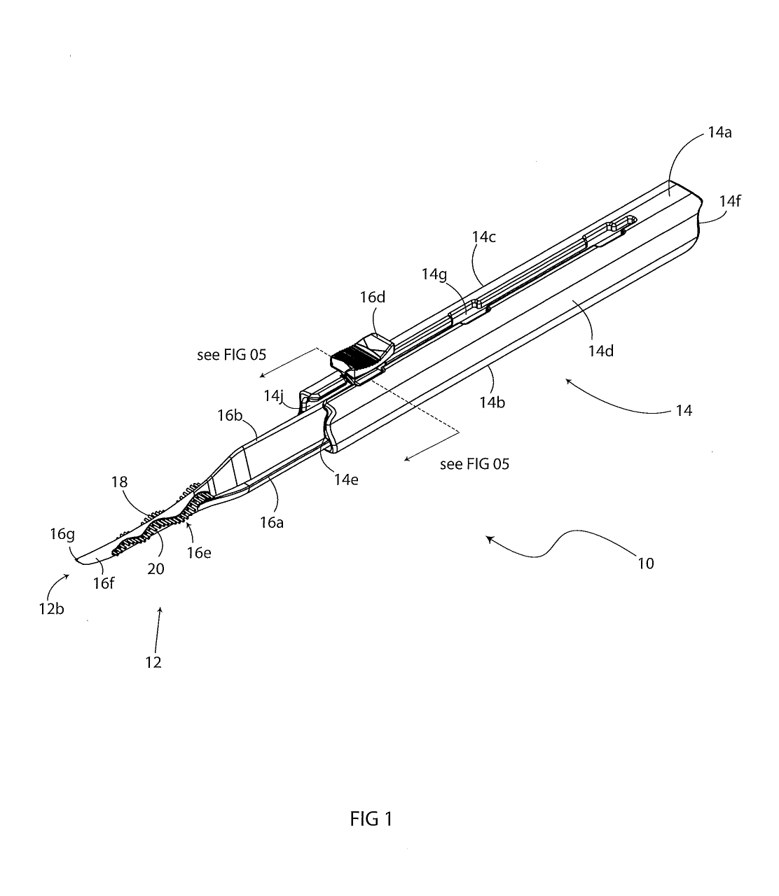

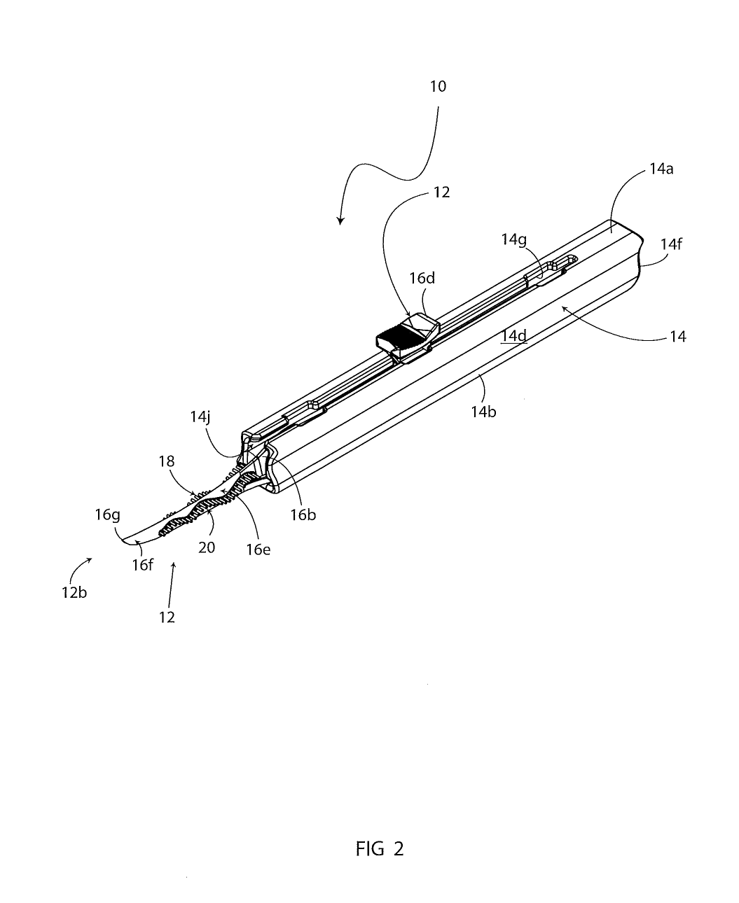

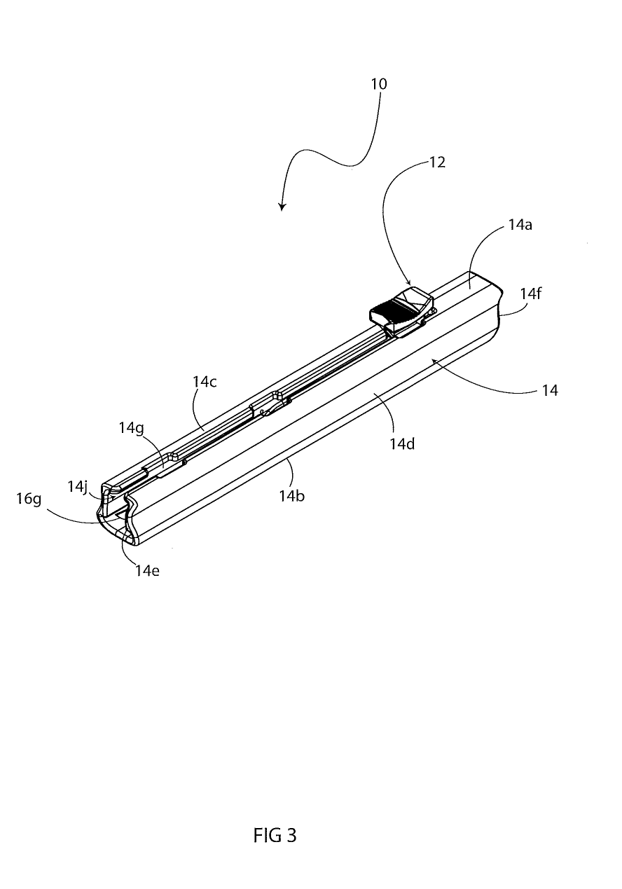

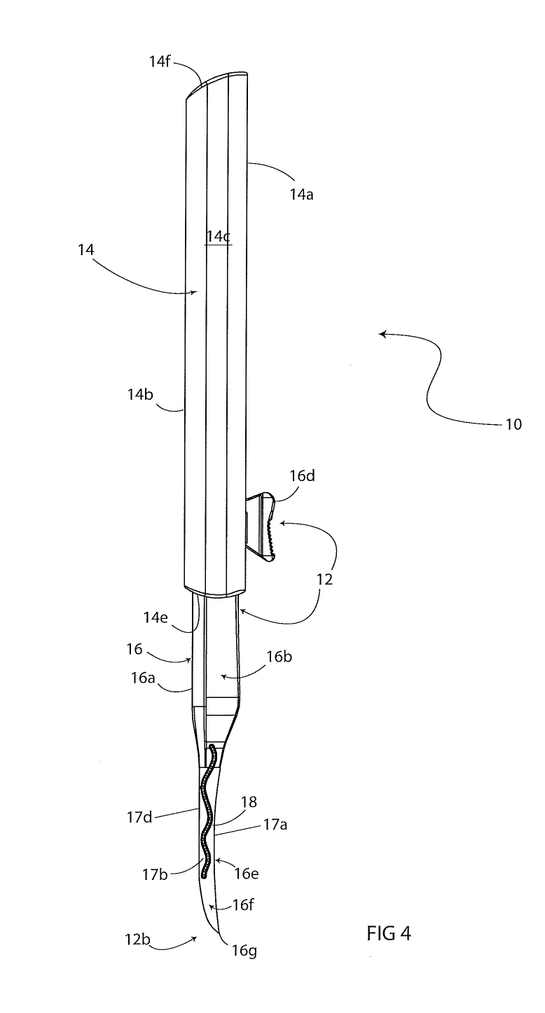

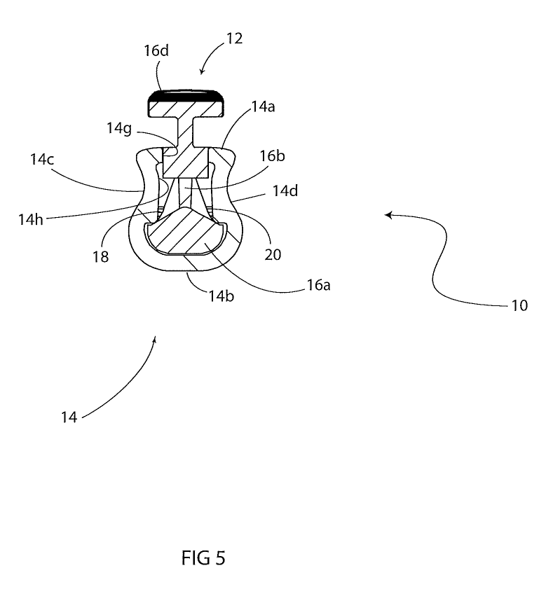

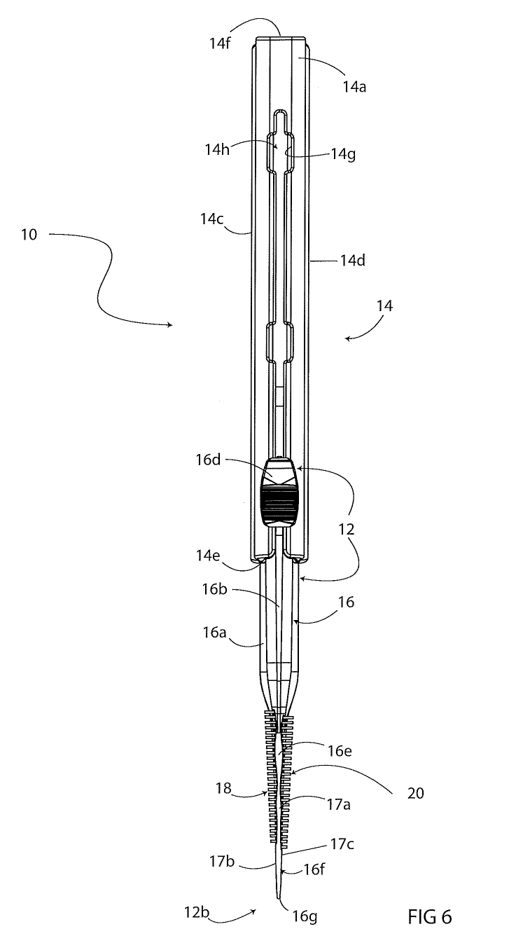

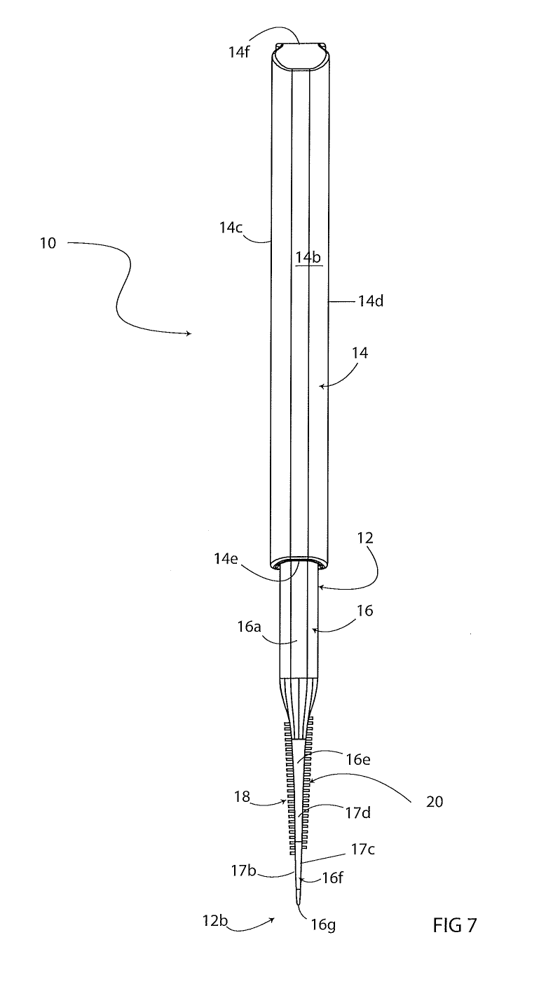

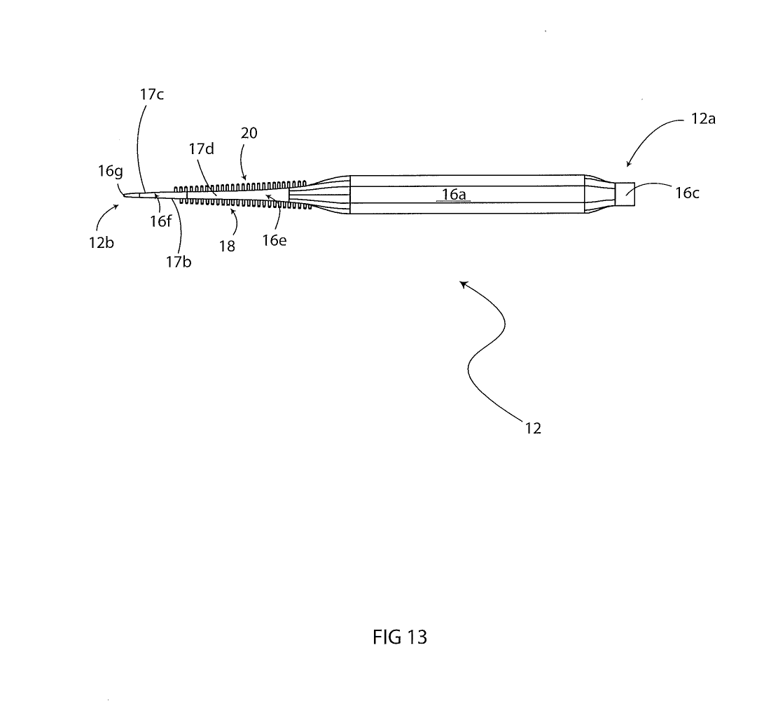

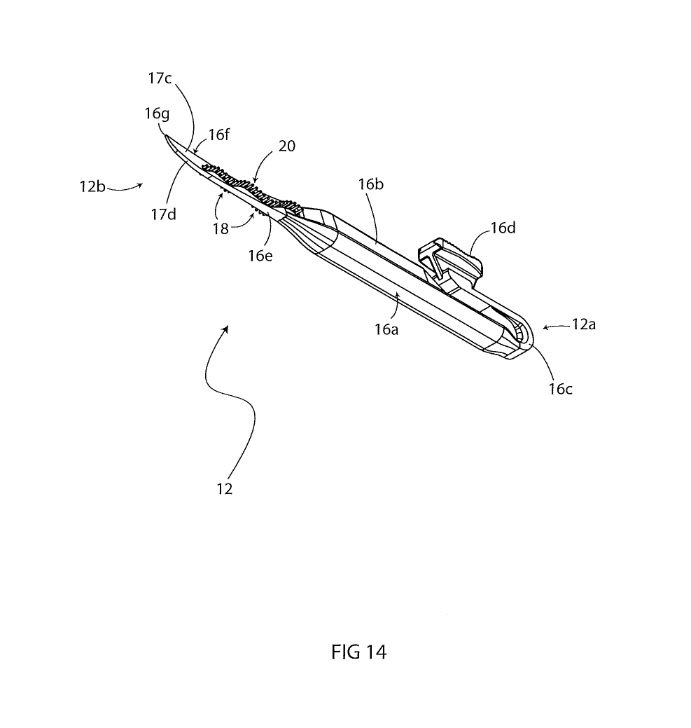

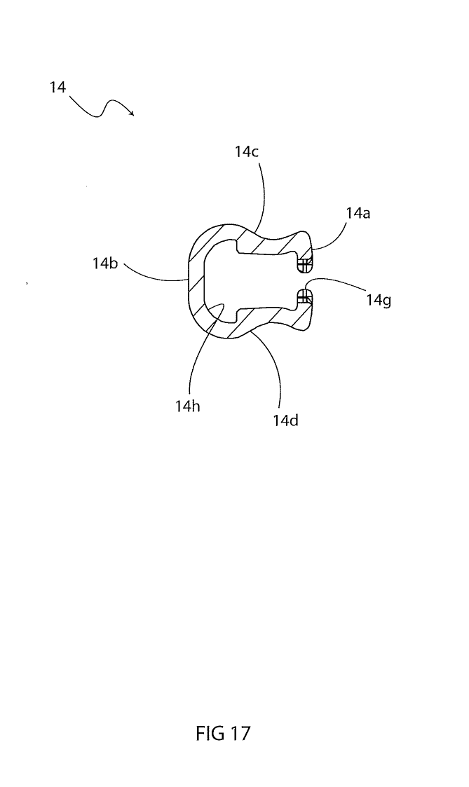

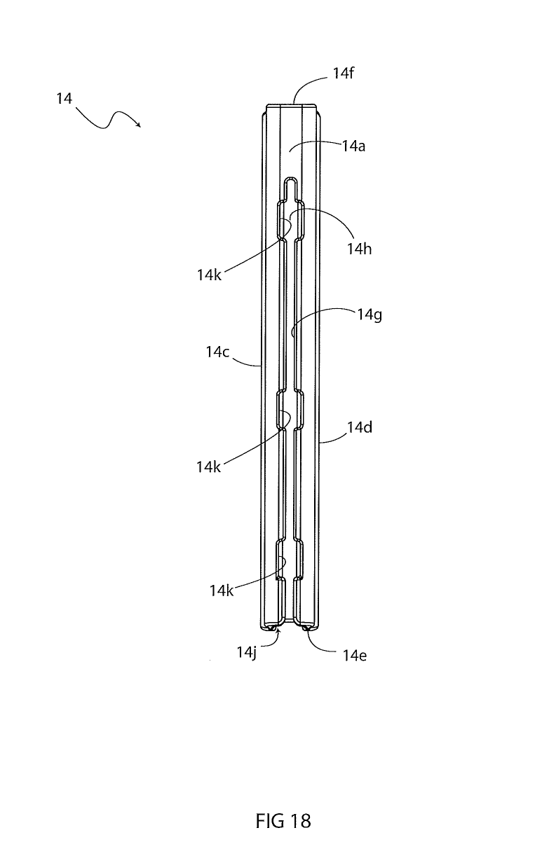

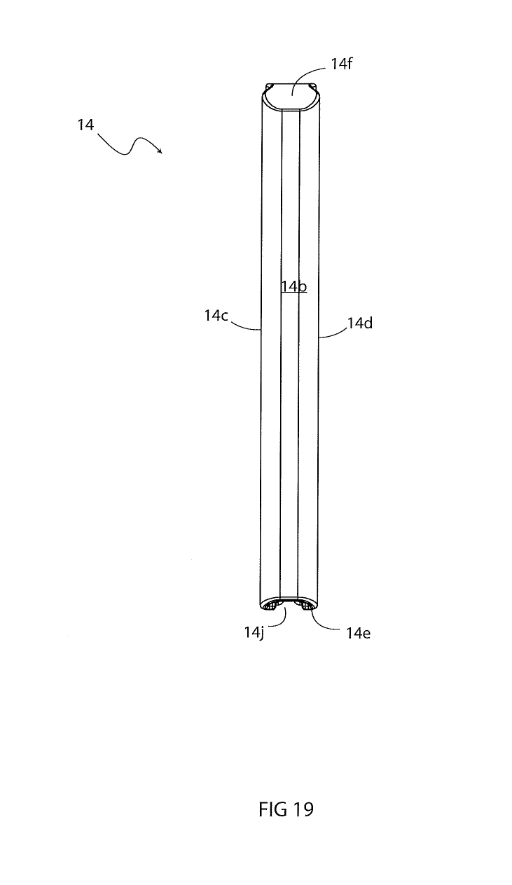

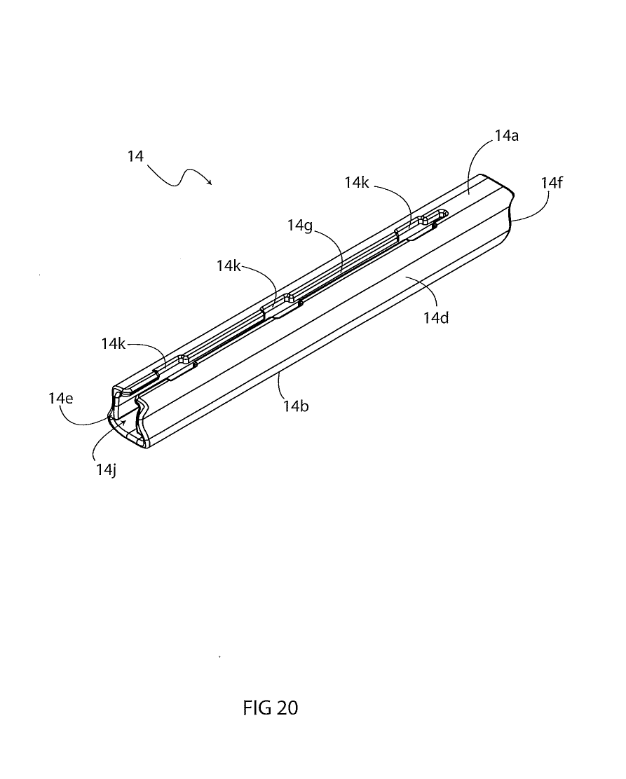

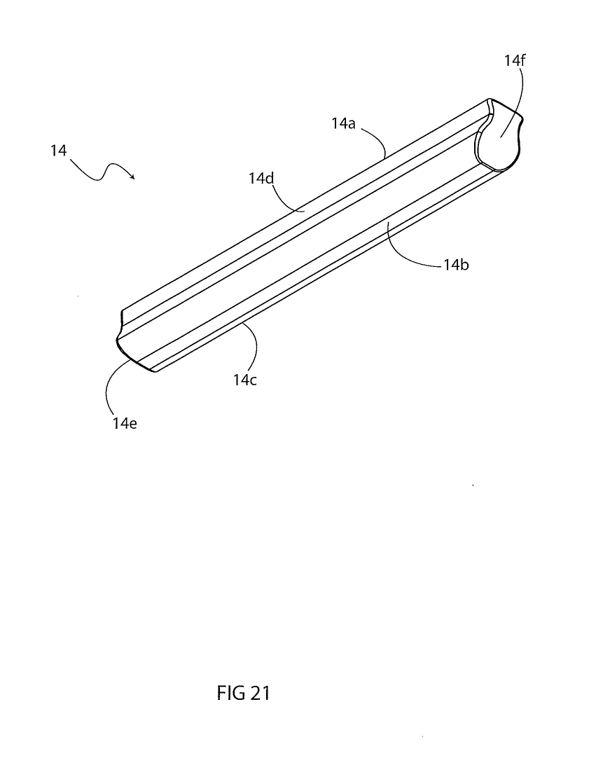

Referring to FIGS. 1-21 there is shown a dental implement in accordance with an aspect of the present invention; generally indicated at 10. Dental implement 10 comprises a toothpick assembly 12 and a cover 14. A first end of toothpick assembly 12 is insertable into cover 14 and is securable thereto (as will be hereafter described), and toothpick assembly 12 is selectively movable relative to cover 14 between a fully extended first position (FIG. 1) and a fully retracted second position (FIG. 3). In the fully extended position, toothpick assembly 12 is ready for use to clean debris and plaque from an interdental space and, in the fully retracted position; toothpick assembly 12 does not extend out of the cover and therefore cannot be used to clean between teeth. Toothpick assembly 12 may also be selectively positioned at a partially extended position (FIG. 2) for more discrete usage than when in the fully extended position. The user is therefore able to select whether they wish to use the toothpick in the fully extended position or in the partially extended position. Cover 14 serves a number of different purposes. Firstly, cover 14 acts as a type of handle that is readily gripped when using toothpick assembly. Secondly, cover 14 protects toothpick assembly 12 in the fully retracted position and therefore makes it easier to store in a purse or pocket. Finally, cover 14 keeps toothpick assembly 12 in a sanitary condition and substantially prevents toothpick assembly 12 from coming into contact with other objects. Toothpick assembly 12 may selectively be disengaged from cover 14 and be discarded. A replacement toothpick assembly may then be engaged with cover 14.

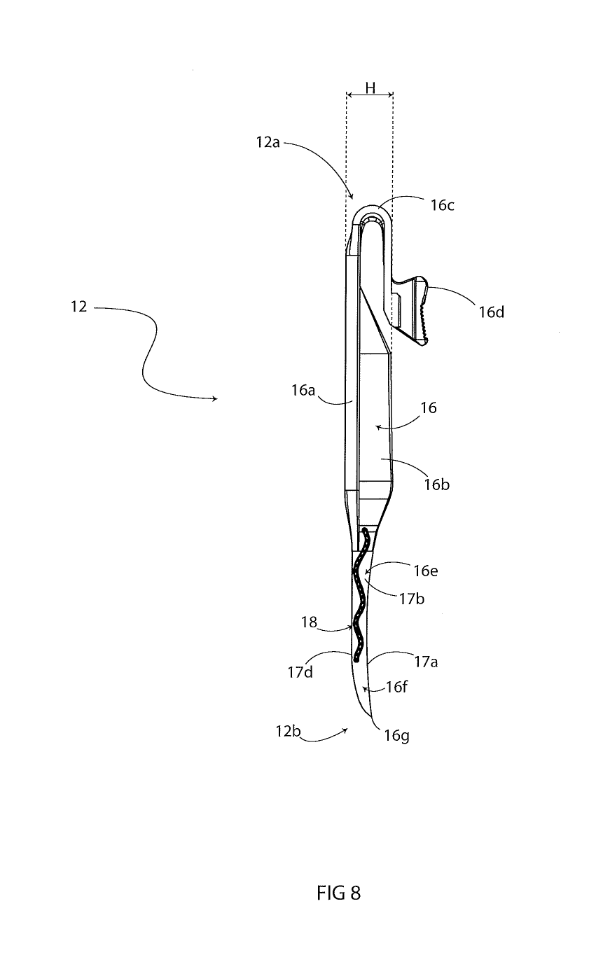

Referring to FIGS. 8-15, toothpick assembly 12 is shown in greater detail. Toothpick assembly 12 has a first end generally indicated at 12a and a second end generally indicated at 12b. First end 12a is inserted into through an opening at one end of cover 14 and into an interior chamber. First end 12a is substantially always positioned within the interior chamber of cover 14 when toothpick assembly 12 is engaged with cover 14. Second end 12b of toothpick assembly is selectively received within the interior chamber of cover 14 when toothpick assembly 12 is moved to the fully retracted storage position (FIG. 3). Second end 12b selectively extends outwardly from the opening to the interior chamber of cover 14 when toothpick assembly 12 is moved to the partially extended position (FIG. 2) or the fully extended position 12b.

Toothpick assembly 12 comprises a base, a locking assembly and a toothpick. The locking assembly is provided at one end of the base and the toothpick is provided at the other end of the base. Generally speaking, the locking assembly is located at the first end 12a of toothpick assembly 12 and a tip of the toothpick is located at the second end 12b of toothpick assembly 12.

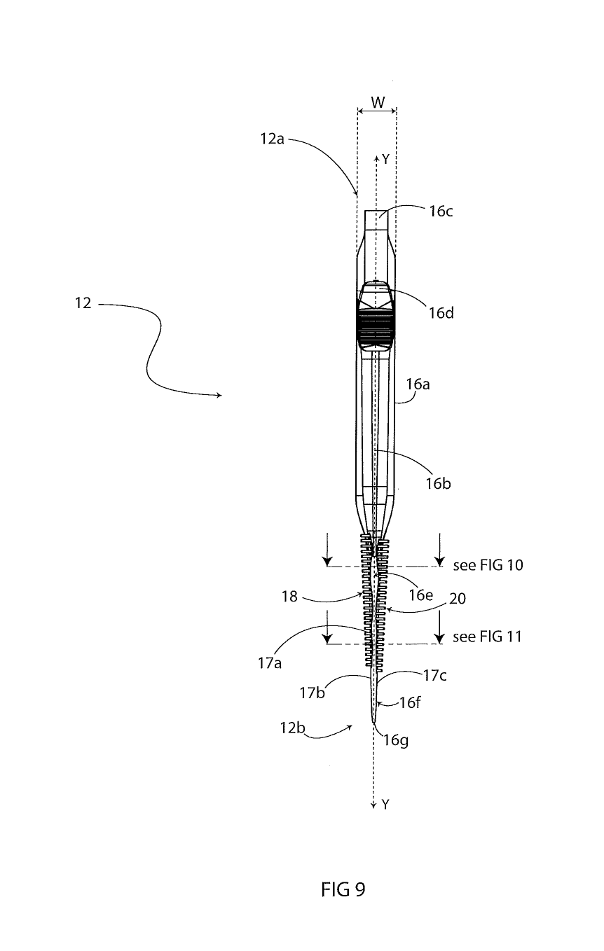

The base may be of an inverted T-shape that includes a generally horizontally-oriented wall 16a and a generally vertically-oriented wall 16b. Wall 16b may be located centrally along a longitudinal axis “Y” (FIG. 9) of wall 16a and extends upwardly and outwardly from wall 16a and at right angles relative thereto. FIG. 8 shows that wall 16a has a maximum height “H” and FIG. 9 shows that wall 16b has a maximum width “W”.

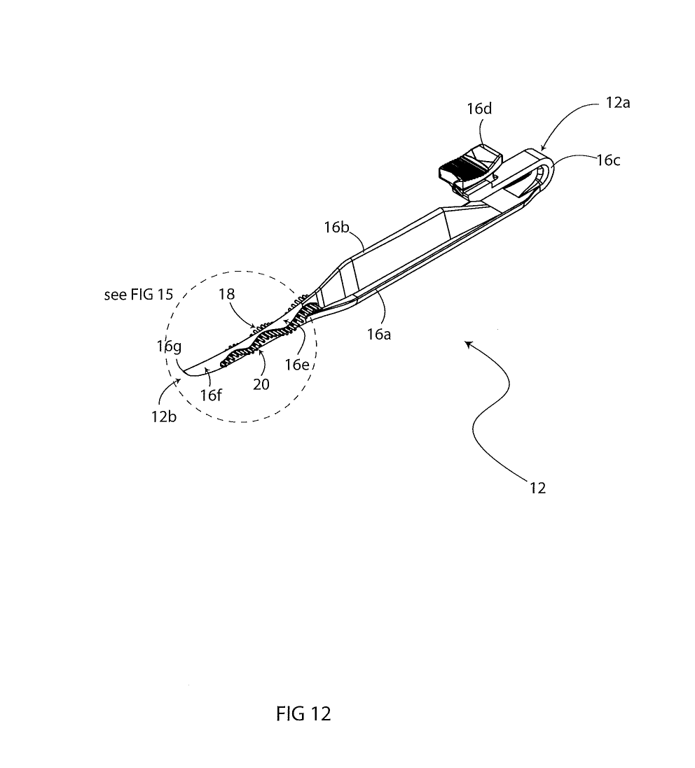

As shown in FIGS. 8 and 12, a first end of wall 16b tapers in height until wall 16b substantially disappears into wall 16a. Wall 16a tapers somewhat in width and then curls upwardly and back over a portion of itself, thereby forming an arm 16c. An end of the arm 16c is narrowed and a button 16d is formed at a terminal end of the arm 16c. Button 16d is located over the tapering region of wall 16b and button 16d itself is located a distance vertically beyond an outermost edge of wall 16b. Arm 16c and button 16d together form the locking assembly for toothpick assembly 12. Arm 16c and the portion of wall 16a over which arm 16c extends are configured into a U-shape (FIG. 8). Arm 16c is inserted into the opening in cover 14 and button 16d may be depressed downwardly toward wall 16a in the direction of arrow “A” (FIG. 8) to allow toothpick assembly 12 to move relative to cover 14. When button 16d is depressed, part of arm 16c is compressed and moved downwardly toward wall 16a. When downward pressure is removed from button 16d, the downwardly flexed part of arm 16c will return to its original position moving in the opposite direction to arrow “A”. When button 16d moves back to its original position it locks toothpick assembly 12 in position relative to cover 14. Button 16d is thus effectively spring-loaded. The locking assembly, i.e., arm 16c and button 16d are utilized to retain toothpick assembly 12 within cover 14 and to secure toothpick assembly 12 in specific locations within cover 14.

At the second end of the base opposite from arm 16d, wall 16a once again tapers in height (FIG. 8) and wall 16b tapers in width. The toothpick extends outwardly from this tapering region of the base 16a/16b. The toothpick includes a first region that has a plurality of bristles thereon and is therefore further described herein as bristled region 16e. The toothpick also includes a second region that extends outwardly from the first region along longitudinal axis “Y” and may be bristle free and therefore more like a conventional toothpick. This second region is therefore further described herein as pick region 16f. Bristled region 16e extends outwardly from the base 16a/16b and pick region 16f extends outwardly from bristled region 16e and terminates in a tip 16g. Tip 16g comprises the second end 12b of toothpick assembly 12.

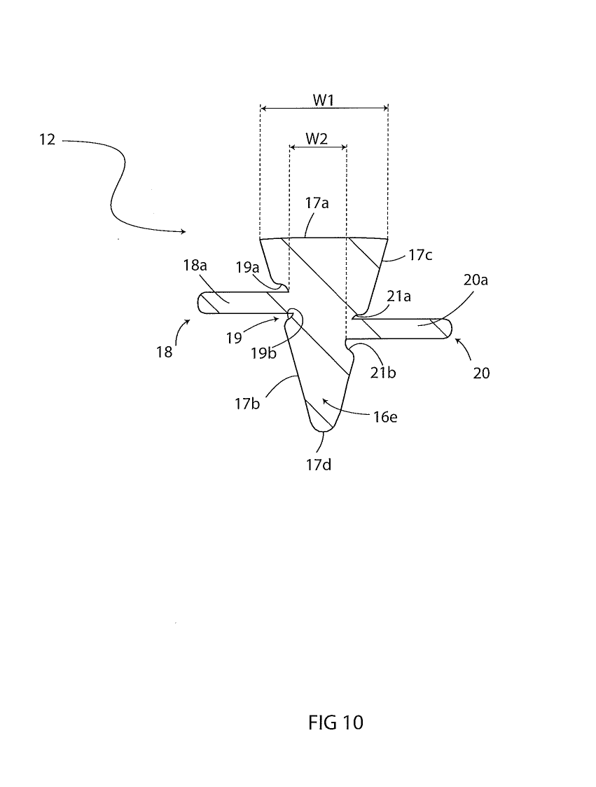

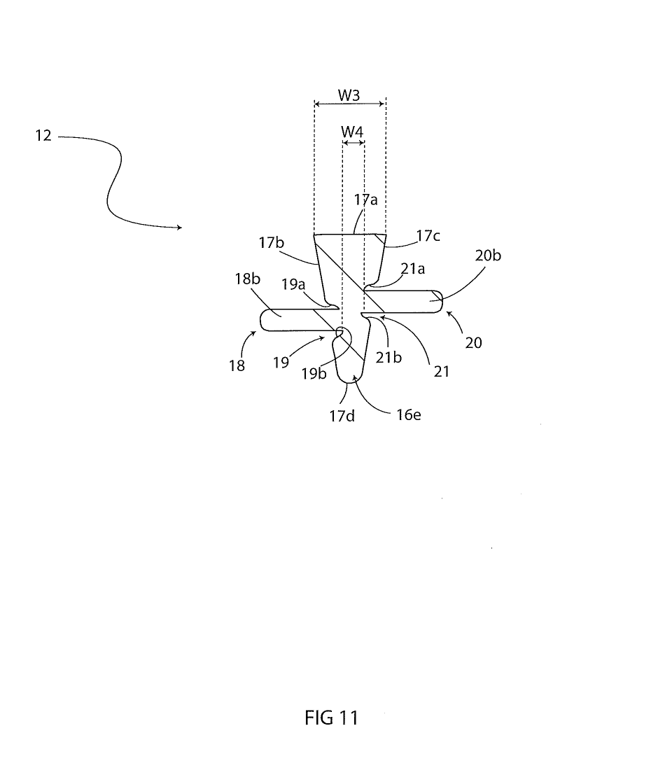

As shown in FIGS. 10 and 11, each of bristled region 16e and pick region 16f may be generally triangular in cross-section. The overall dimensions of pick region 16f may be smaller than the overall dimensions of bristled region 16e. The triangular cross-section of the toothpick gradually tapers in size as one moves away from base 16a/16b and outwardly to tip 16g of pick region 16f. Each of the bristled region 16e and pick region 16f may include a first face 17a a second face 17b and a third face 17c arranged to form a generally triangular shape. This triangular shape may be inverted so that an apex 17d of the triangle may form a bottom surface of bristled region 16e and pick region 16f. Apex 17d is located opposite first face 17a and second and third faces 17b, 17c extend from opposite ends of first face 17b downwardly to apex 17d. Second and third faces 17b, 17c intersect at apex 17d. When toothpick assembly 12 is used, terminal tip 16g may be inserted into an interdental space in such a way that apex 17d may be positioned adjacent the gingiva. The rounded shape of apex 17d helps ensure that toothpick assembly 12 will not tend to harm the gingiva when assembly 12 is moved back-and-forth and up-and-down during use. As shown in FIGS. 10 and 11, first face 17a and apex 17d are bristle-free and bristles extend outwardly from each of second face 17b and third face 17c.

FIGS. 8-15 also show that bristled region 16e may be provided with two rows of bristles, with each row extending outwardly from opposite side surfaces of the bristled region. Each row of bristles includes a plurality of thin, small, individual flexible bristles that are spaced a distance apart from each other. The individual bristles may be spaced at regular intervals from each other or may be spaced at irregular intervals.

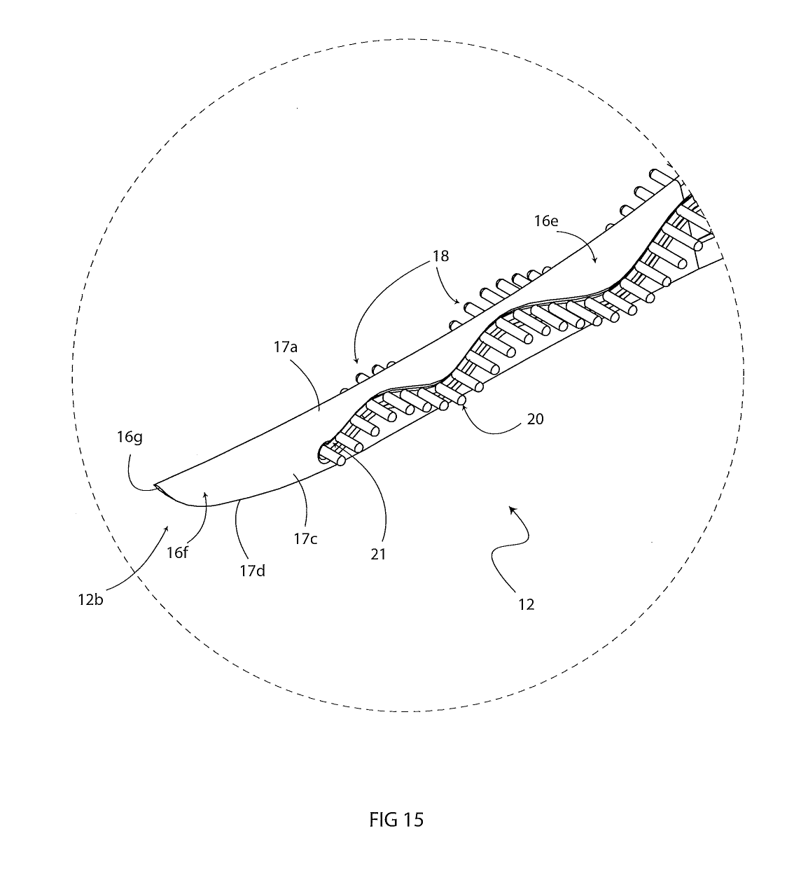

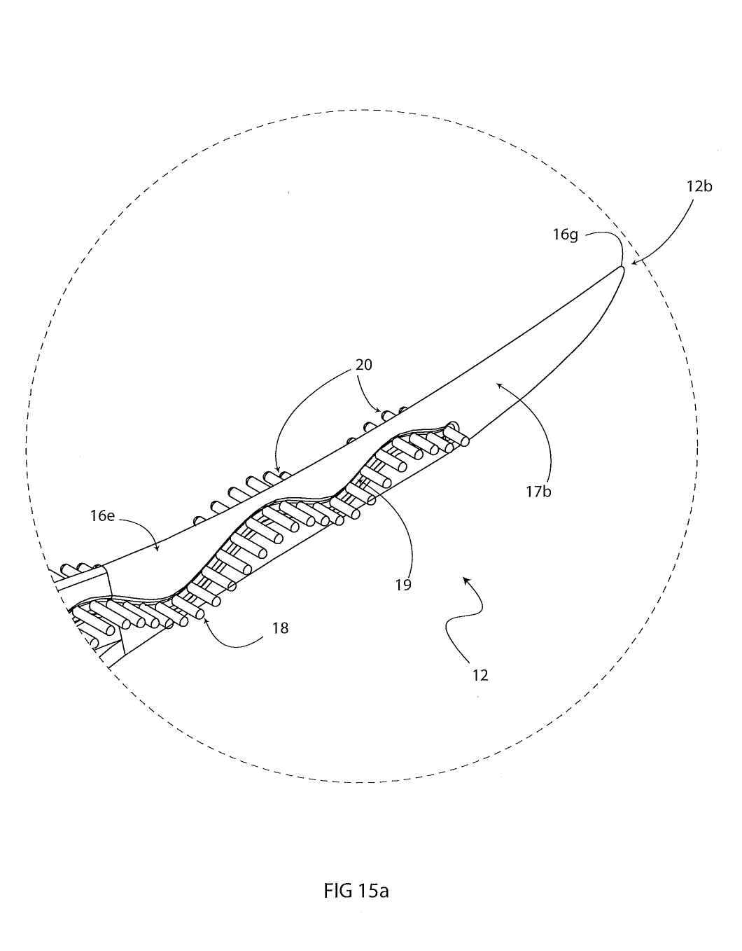

FIG. 9 shows that a first row 18 of bristles extends outwardly from second face 17b of bristled region 16e and a second row 20 of bristles extends outwardly from third face 17c of bristled region 16e. FIGS. 8, 15 and 15a show that each of first and second rows 18, 20 is arranged in a sinusoidal pattern along the respective second or third face 17b, 17c. Each row of bristles 18, 20 originates in the tapering region of wall 16b and terminates a distance inwardly from tip 16g. That portion of the toothpick that is bristle-free and extends between tip 16g and the first bristle of either row 18, 20 makes up the pick region 16f of the toothpick.

The bristles that form first row 18 of bristles may not be horizontally aligned with the bristles that form second row 20 of bristles. The bristles in the two rows 18, 20 may be staggered relative to each other. This is shown in FIGS. 10 and 11. FIG. 10 shows that a bristle 18a from first bristle row 18 is located a distance further way from apex 17d than a bristle 20a from second bristle row 20. FIG. 11 shows that a bristle 18b from first bristle row 18 is located a distance closer to apex 17d than a bristle 20b from second bristle row 20. Occasionally, a bristle from first bristle row 18 may be horizontally aligned with a bristle from second bristle row 20 but this may not typically be what occurs.

FIGS. 10 and 11 also illustrate that the bristles 18a, 18b and 20a, 20b (and all the other bristles in each of the first and second bristle rows 18, 20) may be injection molded with and form an integral part of the bristle region 16e of toothpick assembly 12 from which they extend. In other words, bristles 18a, 18b, 20a, 20b may not be components that are separately fabricated and then engaged with second and third faces 17b, 17c of bristle region 16e. Instead, bristles 18a, 18b, 20a, 20b and all the other bristles of first and second bristle row 18, 20 may be integral parts of second and third faces 17b, 17c. Substantially the entire toothpick assembly 12 may be injection molded as a single unit. In other words, the base (walls 16a, 16b), the locking assembly (arm 16c and button 16d), and the toothpick (bristled region 16e and pick region 16f) may comprise a single, integral, monolithic, unitary component. Consequently, the entire toothpick assembly 12 may be fabricated out of the same material. A suitable material for this purpose may be polypropylene (PP). Any other flexible plastic may, however, be used instead to fabricated toothpick assembly 12. Toothpick assembly 12 may also be fabricated to include materials that aid in removing plaque or food debris from a tooth surface. So, for example, perlite may be added into the material from which toothpick assembly 12 is fabricated.

Referring still to FIGS. 10, 11, 15 and 15a, the individual bristles in each of first and second rows of bristles 18, 20 extend outwardly from within a recessed region provided in second face 17b and third face 17c respectively. The presence of these recessed regions enables the individual bristles in first and second bristle rows 18, 20 to bend easily. The individual bristles start below the outer surface of the associated second or third face 17b, 17c and are able to bend forward or backward, up or down more readily than if the recessed regions were not defined in second and third faces 17b, 17c. The part of each bristle that tends to bend through 90 degrees may be positioned at or below the outer surface of the associated second or third face 17b, 17c. In other words, the bristles tend to bend within the recessed region not at a location spaced a distance laterally outwardly from the associated outer surface of second or third face 17b, 17c. The presence of the recessed regions and the fact that each bristle originates therein aids in keeping the width of bristled region 16e (from second face 17b to third face 17c) as narrow as possible.

Because the bristles in first and second bristle rows 18, 20 are very small and thin, the recessed regions may take the form of a groove that is defined in each of the second or third faces 17b, 17c. This is illustrated in FIG. 15 and FIG. 15a. A first groove 19 may be defined in second face 17b and the plurality of bristles that make up the first row of bristles 18 originate in an innermost wall which defines first groove 19. The bristles of first bristle row 18 extend outwardly from first groove 19 and beyond an outer surface of second face 17b. A second groove 21 may be defined in third face 17c and the plurality of bristles that make up second row of bristles 20 originate in an innermost wall which defines second groove 21. The bristles of second bristle row 20 extend outwardly from second groove 21 and beyond an outer surface of third face 17c.

Each of the first and second grooves 19, 21 may be serpentine or sinusoidal in shape and extend from a location proximate or in wall 16b to location spaced a short distance away from tip 16g. Grooves 19, 21 and therefore first and second bristle rows 18, 20 may not be laterally aligned with each other but may instead be laterally staggered or misaligned relative to each other. In other words, the left side surface and right side surface of toothpick assembly 12 may not be mirror images of each other. This lateral staggering or misalignment of first and second bristle row 18, 20 can be seen in FIGS. 10 and 11. The staggered pattern in first and second grooves 19, 21 and first and second rows 18, 20 may help bristled region 16e of toothpick assembly 12 to bend and flex more readily during use. The staggered pattern may also help to create better movement of individual bristles in each of the first and second bristle rows 18, 20.

As best seen in FIGS. 10 and 11, a first part of the first groove 19 is located above an upper surface of the bristles in first bristle row 18 and this first part of the first groove is indicated by the reference number 19a. A second part of the first groove 19 is located below a lower surface of the bristles in first bristle row 18 and is indicated by the reference number 19b. Similarly, a first part 21a of second groove 21 is located above the upper surface of the bristles in second bristle row 20 and a second part 21b of second groove 21 is located below the lower surface of the bristles in second row 20. First part 19a and second part 21b are substantially similar in cross-sectional shape and are of a first configuration. Second part 19b and first part 21a are substantially similar in cross-sectional shape and are of a second configuration. However, the first configuration and the second configuration are different. The first configuration may be considered to be more U-shaped and the second configuration may be considered to be more V-shaped. The staggered cross-sectional shape of the parts of the grooves 19, 21 above and below bristle rows 18, 20 provides for improved flexing of the bristles in bristle row 18, 20 in both a back-and-forth motion and an up-and-down motion.

FIG. 10 shows that first face 17a of bristled region 16e at the location where cross-section 10-10 is taken in FIG. 9 has a width “W1”. Width “W1” is that distance between the location where first face 17a intersects second face 17b and where first face 17a intersects third face 17b, i.e., from one side edge of first face 17a to the other. Bristled region 16e also has a width “W2” part way down second and third faces 17b, 17c, where that width is measured from an innermost region of first groove 19 to an innermost region of second groove 21. Width “W2” is smaller than width “W1”. Similarly, in FIG. 11, first face 17a, at the point indicated by line 11-11 of FIG. 9, is of a width “W3” (which is less than width “W1”) and the width from an innermost region of first groove 19 to an innermost region of second groove 21 is of a width “W4”. Width “W4” is smaller than width “W3” and is also smaller than width “W2”. At all points along bristled region 16e, the width of the region measured between the two serpentine grooves 19, 21 (such as widths “W2”, “W4”) is narrower than the width of the first face 17a (such as widths “W1”, “W3”). The provision of grooves 19, 21 and thereby the narrower width of bristled region 16e between these grooves, along with the provision of dissimilar configurations in the upper and lower regions 19a, 19b, 21a, 21b of grooves 19, 21 helps to ensure that the bristles in bristle rows 18 and 20 are more readily able to bend and flex during use of toothpick assembly 12. The width “W1” of first face 17a and the width “W2” both taper from proximate base 16a/16b to proximate tip 16g. Furthermore, the overall width of bristled region 16e tapers from proximate base 16a/16b to tip 16g and this helps ensure that tip 16g and bristled region 16e are thin enough to be able to be inserted into an interdental space. Tip 16g is of the narrowest width (measured from second face 17b to third face 17c) and pick region 16f and bristled region 16e gradually get progressively wider to ensure that bristle rows 18, 20 will brush along the surfaces of the teeth bounding the interdental space. In addition to the bristles in bristle rows 18, 20 being arranged in a sinusoidal pattern, the bristles in each row 18, 20 are longer proximate wall 16b and decease in length, i.e., taper in size as one moves away from the first end of the base and toward terminal tip 16g. Thus, the longest bristles in each row 18, 20 are closer to vertical wall 16b and the shortest bristles are proximate pick region 16f. This configuration also assists in ensuring that the toothpick on toothpick assembly 12 is able to be inserted at least partially into a fairly tight interdental space.

The sinusoidal pattern of first and second grooves 19, 21 and first and second bristle rows 18, 20 may ensure that more of the surface area of a tooth is cleaned than if the bristles were simply placed in a straight line along second and third faces 17b, 17c. It will be understood however, that the bristles may, alternatively, be placed in any other suitable pattern that will enable an increased surface area of a tooth to be more readily cleaned than if the bristles were simply placed in straight rows along second and third faces 17b, 17c. If the bristles are to be arranged in a different pattern than a sinusoidal pattern, then the associated recessed regions will be defined in a complementary pattern.

Instead of the recessed regions provided on toothpick assembly 12 being in the form of first and second grooves 19, 21, the recessed regions may comprise a plurality of individual dimples defined in second face 17b and third face 17c. In this instance each individual bristle in first and second bristle rows 18, 20 may arise within that portion of the faces 17b, 17c which defines the associated dimple and then extend outwardly from within the dimple. Alternatively, a few individual bristles may arise in each dimple and extend outwardly therefrom. The spaced apart dimples may be arranged in a sinusoidal pattern or in any other pattern that ensures that the side surfaces of the teeth bounding an interdental space will be brushed and therefore cleaned by the bristles. Any other type or shape of recessed region may be employed in toothpick assembly 12. So, for example, the recessed regions may take the form of a combination of grooves and dimples that are arranged in a sinusoidal pattern or in any other desired pattern.

Referring to FIGS. 15 and 15a, pick region 16f including tip 16g may be bristle free and therefore be able to be used in a similar fashion to known wooden or plastic toothpicks. Pick region 16f may curve slightly upwardly to make it easier to insert tip 16g and then the rest of pick region 16f into an interdental space. It should further be understood that while pick region 16f is illustrated and described as being substantially bristle-free, bristles may be provided thereon if that is desirable. If this is the case, the recessed regions of bristled region 16e may be continued substantially all the way to tip 16g and any bristles then provided on pick region 16f may be provided to extend outwardly from within these recessed regions. Any bristles provided on pick region 16f would also likely taper in length so that the shortest bristles would be located proximate tip 16g and the longest bristles would be located proximate bristled region 16e.

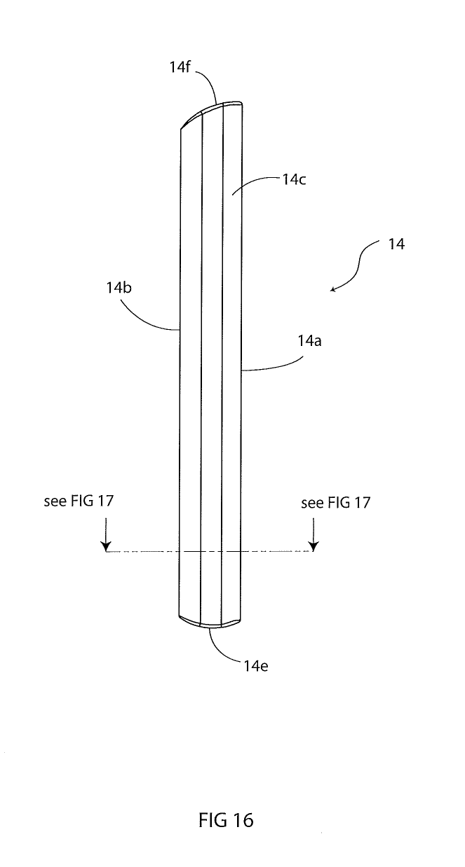

Referring now to FIGS. 16-21, cover 14 has a top wall 14a, a bottom wall 14b, a first side wall 14c, a second side wall 14d, and a first end wall 14e, and a second end wall 14f. A slot 14g is defined in top wall 14a and a chamber 14h is bounded and defined by walls 14a-14f. Slot 14g is in communication with chamber 14h. An opening 14j to chamber 14h is defined in first end wall 14e. Slot 14g is also in communication with opening 14j. A plurality of notches 14k is defined in top wall 14a. Notches 14k are spaced longitudinally from each other and are configured to selectively receive a portion of button 16d therein to lock toothpick assembly 12 in one of three possible positions within cover 14. Cover 14 is substantially identical in structure and function to the cover described in U.S. patent application Ser. No. 14/063,288 (which is incorporated herein by reference) and therefore will not be further described herein. Additionally, the interlocking engagement of toothpick assembly 12 and cover 14 and the extension and retraction of toothpick assembly 12 with respect to cover 14 is substantially identical to what is described in U.S. patent application Ser. No. 14/063,288 and therefore will not be further discussed herein.

It will be understood that while toothpick assembly 12 has been described herein as having a bristle free region 16f that extends from the forwardmost end of the rows of bristles 18, 20, alternatively, the rows of bristles 18, 20 may extend all the way to the tip 16g, ever decreasing in size.

It will further be understood that while a single row of bristles is disclosed as being provided on each of the second and third faces 17b, 17c of bristled region 16e, more than a single row of bristles may be provided on these faces 17b, 17c.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration set out herein are an example and the invention is not limited to the exact details shown or described.

1. A toothpick assembly comprising:
a base having a first end and a second end;
a locking assembly provided at the first end of the base, said locking assembly being adapted to secure the base to a cover;
a toothpick provided at the second end of the base; wherein the toothpick includes:
a first region and
a plurality of bristles extending outwardly from the first region.

2. The toothpick assembly as defined in claim 1, wherein the plurality of bristles are integrally formed with the first region, and wherein the base, locking assembly, first region and the plurality of bristles are a monolithic unitary component.

3. The toothpick assembly as defined in claim 1, wherein the first region is generally triangular in cross-section and includes a first face and an apex opposite the first face; and a second face and a third faces extend from opposing ends of the first face to the apex; and wherein some of the plurality of bristles are provided on the second face and some of the plurality of bristles are provided on the third face.

4. The toothpick assembly as defined in claim 3, wherein one or both of the first face and the apex are free of bristles.

5. The toothpick assembly as defined in claim 3, further comprising a first groove defined by the second face; and wherein the plurality of bristles includes a first row of bristles and the first row of bristles extends outwardly from within the first groove.

6. The toothpick assembly as defined in claim 5, wherein at least a portion of each of the plurality of bristles in the first row of bristles extends outwardly beyond an outer surface of the second face.

7. The toothpick assembly as defined in claim 5, wherein the first groove is sinusoidal.

8. The toothpick assembly as defined in claim 5, wherein the first face has a width measured from an intersection of the first face and the second face to an intersection of the first face and the third face; and wherein the width of the first face tapers as one moves away from the first end of the base and toward a tip of the toothpick.

9. The toothpick assembly as defined in claim 5, wherein the first groove is of a first configuration above the first row of bristles and is of a second configuration below the first row of bristles; and the first and second configurations are different.

10. The toothpick assembly as defined in claim 9, wherein one of the first and second configurations is generally U-shaped and the other of the first and second configurations is generally V-shaped.

11. The toothpick assembly as defined in claim 5, wherein the plurality of bristles that comprise the first row of bristles are longest proximate the base and decrease in length moving towards a tip of the toothpick.

12. The toothpick assembly as defined in claim 5, further comprising a second groove defined by the third face, and where the plurality of bristles includes a second row of bristles; and the second row of bristles extends outwardly from within the second groove.

13. The toothpick assembly as defined in claim 12, wherein the second groove is sinusoidal.

14. The toothpick assembly as defined in claim 12, wherein the first groove and the second groove are laterally staggered or misaligned relative to each other.

15. The toothpick assembly as defined in claim 12, wherein the first face is of a first width as measured between the second face and the third face; wherein the first region is of a second width as measured between an innermost region of the first groove and an innermost region of the second groove; wherein the second width is smaller than the first width; and wherein the second width tapers as one moves from the first end of the base towards a tip of the toothpick.

16. The toothpick assembly as defined in claim 1, further comprising a second region of the toothpick extending outwardly from the first region thereof; and wherein the second region terminates in a tip.

17. The toothpick assembly as defined in claim 16, wherein the second region is free of bristles.

18. The toothpick assembly as defined in claim 16, wherein the second region is generally triangular in cross-section.

19. The toothpick assembly as defined in claim 1, further comprising a cover; where the cover defines an interior chamber and the first end of the base is received within the interior chamber.

20. The toothpick assembly as defined in claim 19, wherein the locking assembly selectively secures the first end of the base to the cover in one of a first position, a second position and a third position; and when the base is in the first position, at least the second end of the base extends outwardly from one end of the cover; and when the base is in the second position, substantially all of the base is retained within the interior chamber defined by the cover; and when the base is in the third position, part of the base is retained within the interior chamber of the cover and part of the base extends outwardly from the one end of the cover.
